(19) United States
(12) Patent Application Publication
(10) Pub. No.: US 2026/0077575 A1
(43) Pub. Date: Mar. 19, 2026

(54) PROTECTIVE NYLON FABRICS

(71) Applicant: Workers First LLC, Pittsburgh, PA (US)

(72) Inventor: Matthew James Borowiak, JR., Pittsburgh, PA (US)

(73) Assignee: Workers First LLC, Pittsburgh, PA (US)

(21) Appl. No.: 19/269,276

(22) Filed: Jul. 15, 2025

Related U.S. Application Data
(60) Provisional application No. 63/696,142, filed on Sep. 18, 2024.
(60) Provisional application No. 63/739,845, filed on Dec. 30, 2024.

(51) Int. Cl. B32B 27/08; B29B 9/10; B29C 48/08; B29K 77/00; B29K 96/02; B29K 96/04; B32B 27/34; B32B 27/40; B32B 37/18

(52) U.S. Cl. CPC B32B 27/08; B29B 9/10; B29C 48/08; B32B 27/34; B32B 27/40; B32B 37/182; B29K 2077/00; B29K 2096/02; B29K 2096/04; B29K 2995/0016; B32B 2250/03; B32B 2250/40; B32B 2270/00; B32B 2307/3065; B32B 2307/70; B32B 2317/10; B32B 2355/00; B32B 2375/00; B32B 2386/00; B32B 2571/00; D10B 2501/04

(57) ABSTRACT

The instant disclosure relates to textile materials having an acid reactive functionalized polymer layer and a non-acid reactive functionalized layer coupled thereto. The acid reactive functionalized polymer layer may include: a polyamide polymer that captures and neutralizes acidic molecules; a hydrophilic polyether block amide copolymer; a maleic anhydride-grafted ethylene copolymer; and a non-halogenated flame retardant. The acid reactive functionalized polymer layer is fire resistant, acid neutralizing, and allows water vapor to transfer therethrough. The non-acid reactive functionalized layer and acid reactive functionalized polymer layer are free of per- and polyfluoroalkyl substances. The polyamide may include Nylon 12, Nylon 6, or Nylon 6,6 functionalized with an amine (e.g., a pyridine derivative and/or a halogenated-dimethylalkylamine) having a nitrogen that captures and neutralizes acidic molecules. The halogenated-dimethylalkylamine may include a general chemical formula of (CH₃)₂N—R—X, where R is an alkyl containing 1-12 carbon atoms, and X is chlorine or bromine.

### CROSS-REFERENCE TO RELATED APPLICATIONS

This application claims the benefit of U.S. patent application Ser. No. 63/696,142, filed Sep. 18, 2024, and U.S. patent application Ser. No. 63/739,845, filed Dec. 30, 2024, the contents of which are incorporated by reference herein in their entirety.

### TECHNICAL FIELD

The instant disclosure relates to protective fabrics, and more particularly to protective fabrics comprising amine functionalized nylon and the method of making such a fabric.

### BACKGROUND OF THE INVENTION

In industrial environments where chemical exposure is a concern, wearing Personal Protective Equipment (PPE) is essential for protecting workers from harmful substances that can cause burns, respiratory issues, or long-term health effects. PPE such as chemical-resistant gloves, goggles, face shields, and full-body suits acts as a barrier between the worker and hazardous materials, significantly reducing the risk of injury or illness. This protection is especially critical in settings where accidental spills, splashes, or airborne contaminants are common, ensuring that workers can perform their tasks safely and effectively.

Of further interest is the use of PPE that does not contain per- and polyfluoroalkyl substances (PFAS), which avoids the risks associated with PFAS—chemicals often used to make gear water- and stain-resistant but linked to serious health and environmental concerns. PFAS are a group of synthetic chemicals that include perfluorooctanoic acid (PFOA), perfluorooctane sulfonate (PFOS), and many other compounds. PFAS are resistant to heat, water, and oil, making them useful in a variety of industrial and consumer products, such as non-stick cookware, water-repellent clothing, and firefighting foams.

However, PFAS are often referred to as “forever chemicals” because they do not break down easily in the environment or the human body, thereby leading to long-term exposure concerns. PFAS have been linked to various health issues, including cancer, liver damage, thyroid disease, and reproductive problems. For instance, textiles used in personal protective equipment (PPE) can contain PFAS, contributing to cancer diagnoses among chemical workers, firefighters, and military personnel. Developing PFAS-free textiles that are fire and chemical resistant as well as acid neutralizing would offer significant benefits to consumers and enhance safety.

### SUMMARY OF THE INVENTION

In one general aspect, the instant disclosure relates to textile materials having an acid reactive functionalized polymer layer. The textile material may also include a non-acid reactive functionalized layer coupled to the acid reactive functionalized polymer layer. The acid reactive functionalized polymer layer may include: a polyamide polymer that captures and neutralizes acidic molecules; a hydrophilic polyether block amide copolymer; a maleic anhydride-grafted ethylene copolymer; and a non-halogenated flame retardant. The acid reactive functionalized polymer layer is fire resistant, acid neutralizing, and allows water vapor to transfer therethrough. The non-acid reactive functionalized layer and acid reactive functionalized polymer layer are free of per- and polyfluoroalkyl substances (PFAS).

The polyamide may include Nylon 12, Nylon 6, or Nylon 6,6 functionalized with an amine (e.g., a pyridine derivative and/or a halogenated-dimethylalkylamine) having a nitrogen that captures and neutralizes acidic molecules. The halogenated-dimethylalkylamine may include a general chemical formula of (CH₃)₂N—R—X, where R is an alkyl containing 1-12 carbon atoms, and X is chlorine or bromine. The non-halogenated flame retardant may include melamine polyphosphate, aluminum polyphosphate, aluminum hydroxide, and/or magnesium hydroxide. The hydrophilic polyether block amide copolymer is present at 23 wt. % to 80 wt. %. The non-halogenated fire retardant is present at 5 wt. % to 15 wt. %. The polyamide polymer is present at 40-55 wt. %.

The acid reactive functionalized polymer layer is coupled to the non-acid reactive functionalized layer via an adhesive bond and/or a thermal bond. The hydrophilic polyether block amide copolymer increases the moisture vapor transmission rate of the acid reactive functionalized polymer layer as well as has a Shore D hardness value of 35 or greater and a flexural modulus of at least 70 MPa (10,153 psi). The acid reactive functionalized polymer layer is impermeable to liquids. The maleic anhydride-grafted ethylene copolymer is present at 3 wt. % to 15 wt. %. The non-acid reactive functionalized layer is flame resistant as well as includes a nylon material, a cotton material, an aramid material, and/or a spandex material. The non-acid reactive functionalized layer may include a first non-acid reactive functionalized layer and a second non-acid reactive functionalized layer. The acid reactive functionalized polymer layer may be interposed between the first non-acid reactive functionalized layer and the second non-acid reactive functionalized layer. The acid reactive functionalized polymer layer and/or the non-acid reactive functionalized layer may include a thickness of up to 10 μm.

In some aspects, a method for preparing a textile material. The method may include extruding a polyamide polymer to form a first extrusion product, the polyamide polymer captures and neutralizes acidic molecules. The method may also include extruding a combination of the first extrusion product, a hydrophilic polyether block amide copolymer, a maleic anhydride-grafted ethylene copolymer, and a non-halogenated flame retardant to form a second extrusion product. The method may furthermore include pelletizing the second extrusion product. The method may in addition include extruding the second extrusion product to form an acid reactive functionalized polymer film. The method may moreover include affixing the acid reactive functionalized polymer film to a non-acid reactive functionalized layer. The acid reactive functionalized polymer film is water resistant, chemical resistant, fire resistant, acid neutralizing, and allows water vapor to transfer therethrough. The non-acid reactive functionalized layer and the acid reactive functionalized polymer layer are free of per- and polyfluoroalkyl substances (PFAS).

Implementations may include one or more of the following features. The polyamide polymer may include Nylon 12, Nylon 6, or Nylon 6,6 functionalized with an amine. The amine may include: a pyridine derivative and/or a halogenated-dimethylalkylamine; a nitrogen that captures and neutralizes acidic molecules; the halogenated-dimethylalkylamine may include a general chemical formula of (CH₃)₂N—R—X. R is an alkyl containing 1-12 carbon atoms, and X is either chlorine or bromine. The method where the step of affixing the acid reactive functionalized polymer layer proximate to the non-acid reactive functionalized polymer layer may include affixing the acid reactive functionalized polymer layer to the non-acid reactive functionalized polymer layer via an adhesive bond and/or a thermal bond. The non-acid reactive functionalized layer may include a first non-acid reactive functionalized layer and a second non-acid reactive functionalized layer.

The step of affixing the acid reactive functionalized polymer layer proximate to the non-acid reactive functionalized layer may include interposing the acid reactive functionalized polymer layer between the first non-acid reactive functionalized layer and the second non-acid reactive functionalized layer. The method where the non-acid reactive functionalized layer may include a nylon material, a cotton material, aramid material, and/or a spandex material. The non-halogenated flame retardant may include melamine polyphosphate, aluminum polyphosphate, aluminum hydroxide, and/or magnesium hydroxide. The hydrophilic polyether block amide copolymer is present at 23 wt. % to 80 wt. %. The non-halogenated fire retardant is present at 15 wt. % to 75 wt. %. The polyamide polymer is present at 40-80 wt. %.

The maleic anhydride-grafted ethylene copolymer is present at 3 wt. % to 15 wt. %. The hydrophilic polyether block amide copolymer increases the moisture vapor transmission rate of the acid reactive functionalized polymer layer as well as may include a Shore D hardness value of 35 or greater and/or a flexural modulus of at least 70 MPa (10,153 psi). The acid reactive functionalized polymer layer impermeable to liquids.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures for which like references indicate like elements.

FIG. 1 illustrates a sectional view of a textile material, according to some embodiments.

FIG. 2 is a flowchart depicting process steps of a method for preparing a PFAS-free acid neutralizing textile material, according to certain embodiments.

### DETAILED DESCRIPTION

The descriptions of the various embodiments of the instant disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In industrial environments where chemical exposure is a concern, wearing Personal Protective Equipment (PPE) is essential for protecting workers from harmful substances that can cause burns, respiratory issues, or long-term health effects. PPE such as chemical-resistant gloves, goggles, face shields, and full-body suits acts as a barrier between the worker and hazardous materials, significantly reducing the risk of injury or illness. This protection is especially critical in settings where accidental spills, splashes, or airborne contaminants are common, ensuring that workers can perform their tasks safely and effectively.

Of further interest is the use of PPE that does not contain Per- and polyfluoroalkyl substances (PFAS), which avoids the risks associated with per- and polyfluoroalkyl substances—chemicals often used to make gear water- and stain-resistant but linked to serious health and environmental concerns. PFAS are a group of synthetic chemicals that include perfluorooctanoic acid (PFOA), perfluorooctane sulfonate (PFOS), and many other compounds. PFAS are resistant to heat, water, and oil, making them useful in a variety of industrial and consumer products, such as non-stick cookware, water-repellent clothing, and firefighting foams. However, PFAS are often referred to as “forever chemicals” because they do not break down easily in the environment or the human body, thereby leading to long-term exposure concerns. PFAS have been linked to various health issues, including cancer, liver damage, thyroid disease, and reproductive problems. For instance, textiles used in personal protective equipment (PPE) can contain PFAS, contributing to cancer diagnoses among chemical workers, firefighters, and military personnel. Developing PFAS-free textiles that are fire and chemical resistant as well as acid neutralizing would offer significant benefits to consumers and enhance safety.

Embodiments of the instant disclosure will now be described in detail with reference to the FIGS. Embodiments, of the instant disclosure seek to provide a textile material that includes an acid neutralizing amino nylon polymer having a polyamide (e.g., Nylon 12, Nylon 6,6, Nylon 6, similar polyamides, or a combination of two or more thereof) backbone. The polyamide is preferably functionalized with an amine (e.g., a pyridine derivative and/or halogenated-dimethylalkylamine having a general chemical formula of (CH₃)₂N—R—X), wherein the amine group uses its nitrogen atom(s) to capture and neutralize acidic molecules and thereby create a chemical barrier.

Here, R can be an alkyl (e.g., containing 1-12 carbon atoms) and X can be a halogen (e.g., chlorine or bromine). For example, applicable acidic molecules include, but are not limited to, nerve agents and mustard gas. Embodiments of the instant disclosure further seek to provide non-acid reactive functionalized layers that can include synthetic and/or natural materials. In addition, embodiments of the instant disclosure seek to provide films that are formed via extruding the acid neutralizing amino nylon polymer and additional components, which may then be positioned between two or more non-acid reactive functionalized layers to create a chemical barrier. Even more, the instant disclosure seeks to provide acid reactive functionalized films that are allow air and moisture vapor to pass therethrough.

### Embodiment 1

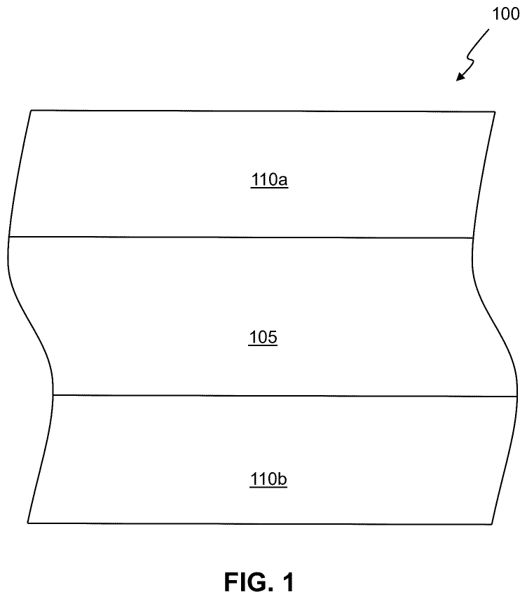

FIG. 1 illustrates a side view of a PFAS-free acid neutralizing textile material, generally 100, in accordance with an embodiment of the instant disclosure. Non-acid reactive functionalized layer 110 and acid reactive functionalized polymer layer 105 are each preferably PFAS-free. Textile material 100 can include acid reactive functionalized polymer layer 105 and one or more non-acid reactive functionalized layers 110 coupled to acid reactive functionalized polymer layer 105. In FIG. 1, non-acid reactive functionalized layer 110 includes first non-acid reactive functionalized layer 110a and second non-acid reactive functionalized layer 110b. Acid reactive functionalized polymer layer 105 is interposed between first non-acid reactive functionalized layer 110a and second non-acid reactive functionalized layer 110b.

For example, acid reactive functionalized polymer layer 105 can be coupled to each non-acid reactive functionalized layer 110 via adhesive bonding and/or thermal bonding. The bonding process can include spray, dot, and/or heat lamination. Non-acid reactive functionalized layer 110 is preferably flame resistant. Non-acid reactive functionalized layer 110 can include synthetic materials/fibers (e.g., nylon, aramids, spandex, other synthetic materials, or a combination of two or more thereof) and/or natural materials/fibers (e.g., cotton, leather, other natural materials, or a combination of two or more thereof). In other embodiments, the aramid is a meta-aramid that is highly resistant to temperature, chemical degradation, and abrasion. Meta aramids are capable of withstanding high levels of stress when exposed to flames or temperatures of up to 400° C.

Acid reactive functionalized polymer layer 105 preferably includes the previously discussed polyamide polymer that captures and neutralizes acidic molecules as well as a hydrophilic polyether block amide copolymer, maleic anhydride-grafted ethylene copolymer, and non-halogenated flame retardant. Inclusion of such components allow acid reactive functionalized polymer layer 105 to be breathable (i.e., allow air and moisture vapor to pass therethrough), impervious to liquid transmission, flame resistant, and acid neutralizing. Acid reactive functionalized polyamide layers produced as described herein are resistant to a plurality of chemicals (e.g., toluene, lactic acid, acetic acid, chloroform, and other hazardous chemicals) in accordance with the American Society for Testing and Materials (ASTM) D 7349/D7349M: 2015, Standard Test Method for Determining the Capability of Roofing and Waterproofing Materials to Seal around Fasteners (published December 15, 2015). As used herein, the term “resistant” refers to the ability of a material to prevent transmission of a chemical through the material. As used herein, the term “breathable” refers to a material's ability to allow air and moisture vapor to pass through it. Water droplets (e.g., rain) typically have an average diameter of at least 20 μm. In contrast, water vapor (e.g., sweat) typically has an average diameter of 10 μm or less.

For example, addition of the hydrophilic polyether block amide copolymer increases the moisture vapor transmission rate of acid reactive functionalized polymer layer 105. The hydrophilic polyether block amide copolymer preferably has a Shore D hardness value of 35 or more and flexural modulus of at least 70 MPa (10,153 psi). Applicable non-halogenated flame retardants can include, but are not limited to, melamine polyphosphate, aluminum polyphosphate, aluminum hydroxide, and magnesium hydroxide. In general, the components can be present at any ratio that supports one or more embodiments of the instant disclosure. For example, the polyamide polymer can be present at 40-55 wt. %, the hydrophilic polyether block amide copolymer can be present at 23 wt. % to 80 wt. %, maleic anhydride-grafted ethylene copolymer can be present at 3 wt. % to 15 wt. %, and the non-halogenated fire retardant can be present at 5 wt. % to 15 wt. %.

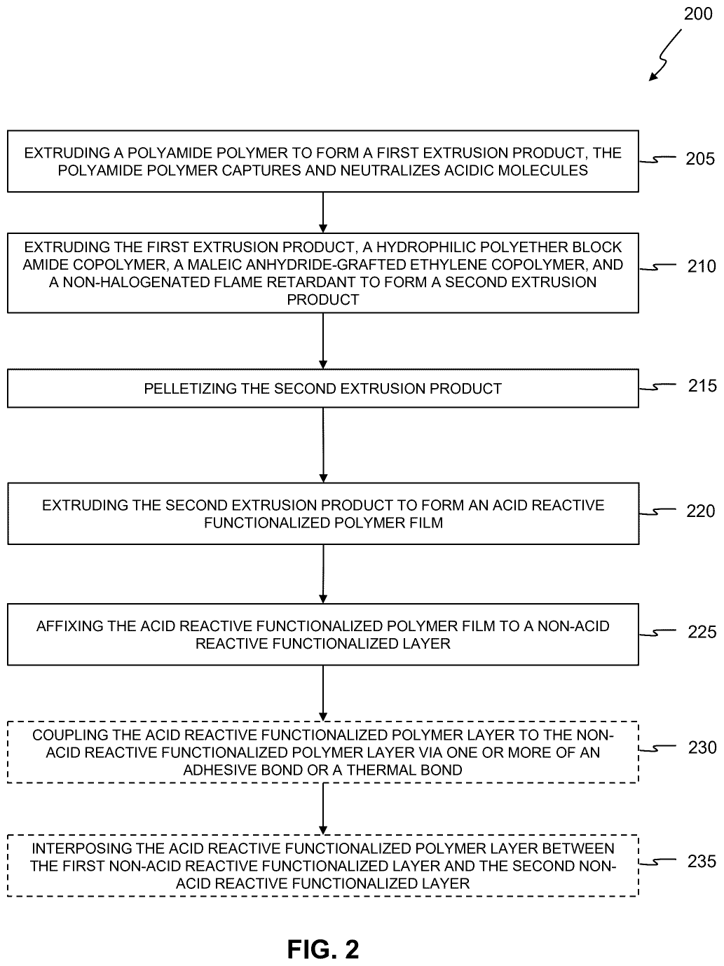

FIG. 2 is a flowchart depicting process steps of a method for preparing a PFAS-free acid neutralizing textile material, generally 200, in accordance with certain embodiments. One or more steps of method 200 can be accomplished using a cast film line. At Step 205, the polyamide polymer is extruded to form a first extrusion product. A single or twin-screw extruder (e.g., set at 70 rpms) is preferably used to form the first extrusion product. Applicable twin-screw extruders include, but are not limited to, intermeshing corotating twin-screw extruders, intermeshing counterrotating extruders, non-intermeshing counterrotating twin screw extruders, and conical twin-screw extruders. For example, the first extrusion product may be in the form of pellets, which are subsequently dried (e.g., for 24 hours at 95° C.). At Step 210, the first extrusion product, a hydrophilic polyether block amide copolymer, a maleic anhydride-grafted ethylene copolymer, and a non-halogenated flame retardant are combined and extruded to form a second extrusion product.

For example, the second extrusion product can be extruded at 200-215°C. At Step 215, the second extrusion product is pelletized. For example, the second extrusion product can be pelletized using an underwater pelletizer. At Step 220, the second extrusion product is extruded (e.g., using a single or twin-screw extruder) to form an acid reactive functionalized polymer film. For example, the second extrusion product is extruded through a die (e.g., via cast extrusion) to thereby form the acid reactive functionalized polymer film at a thickness of 25-100 μm. At Step 225, the acid reactive functionalized polymer film is affixed to a non-acid reactive functionalized layer. In some embodiments, at Step 230, the acid reactive functionalized polymer layer is affixed to the non-acid reactive functionalized polymer layer via one or more of an adhesive bond or a thermal bond.

For example, acid reactive functionalized polymer layer 105 can affixed to non-acid reactive functionalized polymer layer 110 using spray, dot, and/or heat lamination. In yet still other embodiments, the acid reactive functionalized polyamide film may be heated to a temperature of about 200-275°C. whereby the acid reactive functionalized polyamide film may then be pressed and adhered to the non-acid reactive functionalized polyamide film through thermal bonding. Without being limited thereto, thermal bonding of materials may allow for enhanced adhesion between the acid reactive functionalized polyamide film and the non-acid reactive functionalized polyamide film. By way of example and without limitation thereto, the non-acid reactive functionalized polyamide material may be applied to the acid reactive functionalized polyamide film by way of a heated roller. In other embodiments, at Step 235, the acid reactive functionalized polymer layer is interposed between non-acid reactive functionalized layer 110a and non-acid reactive functionalized layer 110b.

### Embodiment 2

In one aspect of the instant disclosure, the acid reactive functionalized polyamide pellets are extruded (e.g., in a twin-screw extruder) by themselves at temperatures between 200-250° C. The acid reactive functionalized polyamide pellets can be dried (e.g., at 75-90° C. and 235-260 mBar for 10-24 hours) prior to extrusion. The extrusion process may utilize a single-screw extruder, twin-screw extruder, or three-screw extruder. The extruded acid reactive functionalized polyamide material may then be pumped into a die head (e.g., a film die) to thereby flatten the extruded polymer into a film. The acid reactive functionalized polyamide polymer film may then be pulled from the die head with at least one roller to thereby extend the extruded film to a predetermined film thickness. While the film may be produced at any thickness, it preferably has a thickness of 20-200 μm or less than 10 μm. The acid reactive functionalized polyamide film roll may then be air dried before undergoing cutting and shaping.

Prior or subsequent to the cutting and shaping process, the acid reactive functionalized polyamide film may be coated with an adhesive (e.g., fabric glue), such as through lamination or spraying. Applicable adhesives can include, but are not limited to, polyurethane or epoxy-based adhesives. Following application of the adhesive, the acid reactive functionalized polyamide film may then be adhered to one or more layers of the non-acid reactive functionalized polyamide material. Additionally, or alternatively, the acid reactive functionalized polyamide material may be thermally bonded to the non-acid reactive functionalized polyamide.

Additionally, or alternatively, a combination of the adhesive bonding and heat bonding may also be used. In this combination process, an adhesive as well as heat may be applied to assure annealing of the various materials to one another. The acid reactive functionalized polyamide film may further function as a chemical barrier within the finalized textile material.

In some aspects of the instant disclosure, the acid reactive functionalized polyamide film is a breathable material. The instant disclosure can include a method for preparing a breathable material that includes laser etching the acid reactive functionalized polyamide layer and/or non-acid reactive functionalized layer to produce at least 1,800 to 4,000 holes per 36 inches² therein. Alternatively, the method can include stretching, subsequent to extruding, the acid reactive functionalized polyamide layer to a thickness of 10 μm or less to thereby produce at least 1,800 to 4,000 holes per 36 inches² therein. To ensure that the material is breathable, each hole preferably has a diameter of 1-10 μm. In other aspects of the instant disclosure, the holes may be arranged with a pitch of 2-4 mm.

### Embodiment 3

In certain aspects, thermoplastic elastomer pellets can be mixed with the acid reactive functionalized polyamide pellets prior to extrusion to generate a polymer pellet blend. The thermoplastic elastomer pellets can be present at 15-45 wt. %. Applicable thermoplastic elastomers include, but are not limited to, polyether and polyamide copolymers. Applicable thermoplastic elastomers can have a Shore D Hardness of 25-45, density of 1.0-1.2 g/cm³, melting point of 145-220° C., refraction index of 1.400-1.512 at 23° C., and surface resistivity of 1.05-3.30 Ω/sq. The polymer pellet blend can be extruded and processed using one or more of the methods described herein to thereby form blended acid reactive functionalized polyamide films.

Comparative testing revealed that the blended acid reactive functionalized polyamide films exhibit improved elasticity and higher hydrophilicity. Further, the blended acid reactive functionalized polyamide films exhibit lower processing temperatures, lower torque and higher throughput compared to the acid reactive functionalized polyamide films discussed above.

### Embodiment 4

In further aspects of the instant disclosure, a PFAS-free textile material can be formed to include an acid reactive functionalized polymer layer and one or more of the non-acid reactive functionalized layers previously discussed. Here, the acid reactive functionalized polymer layer can include one or more components and/or features of the acid reactive functionalized polyamide layer discussed above. The acid reactive functionalized polymer layer can include a polymer (e.g., a polyamine polymer and/or the polyamide polymer), heat resistant silicone elastomer, and mineral fibers. The polymer can also include the thermoplastic elastomer discussed above.

Preferably, the acid reactive functionalized polymer layer is positioned proximate to each non-acid reactive functionalized layer. The acid reactive functionalized polymer layer can have a range of functional properties, including chemical resistance, fire resistance, acid neutralization, and/or the ability to allow water vapor to pass through (i.e., breathability). In some aspects of the instant disclosure, the heat-resistant silicone elastomer includes polydimethylsiloxane (PDMS) or similar silicone elastomers to enhance the “breathability” of the acid reactive functional polymer layer since it is hydrophobic and includes free space for water vapor to pass through. In addition, PDMS prevents liquids and heavier gases from passing through its moisture barrier.

Not to be limited by theory, PDMS creates flexible polymer chains with bulk methyl groups and flexible siloxane bonds, which reduce chain packing density and leaves free-volume spaces in the materials. PDMS's hydrophobicity results from the chemical's ability to prevent water molecules from clogging the pathways used for gas diffusion, which enhances breathability under humid conditions. Applicable mineral fibers can include, but are not limited to, basalt and/or fiberglass, which allow the acid reactive functionalized polymer layer to absorb heat as opposed to melt when exposed to fire.

For example, when exposed to heat, fiberglass and basalt mineral fibers act as a thermal barrier and insulate the polymer from heat penetration. This insulation delays the polymer's exposure to temperatures that can cause combustion or decomposition. When basalt or fiberglass is heated, it crystalizes and forms bonds with the polymer chain rather than facture and allows the polymer membrane to maintain structural integrity without melting. Further, addition of basalt also provides chemical resistance to the acid reactive functionalized polymer layer.

The mineral fibers can be present in the acid reactive functionalized polymer layer at up to 30 wt. %; the polyamine can be present at 50-80 wt. %; and the heat-resistant silicone elastomer can be present at up to 50 wt. %. There are a variety of processes to achieve the multilayered textile material. For example, the acid reactive functionalized polymer layer can be physically coupled to the non-acid reactive functionalized layer(s) via an adhesive bond and/or thermal bond. When the above components are combined, the multilayered textile material (via the acid reactive functionalized polymer layer) exhibits fire resistance, chemical resistance, and acid neutralization. To increase the breathability of the material, the acid reactive functionalized polymer layer and/or non-acid reactive functionalized layer can have a porosity of at least 1,800 to 4,000 holes per 36 inches². Here, each hole can have a diameter of 1-10 μm. In certain embodiments, the holes can be positioned at a pitch of 2-4 mm.

In other aspects of the instant disclosure, the acid reactive functionalized polymer layer can be interposed between a top layer and bottom layer to achieve the multilayered textile material. The top layer and bottom layer can each include, but are not limited to, the non-acid reactive functionalized layer. The acid reactive functionalized polymer layer and non-acid reactive functionalized layer can each have a thickness of up to 10 μm. Alternatively, the thickness can be another value or value range.

In an additional aspect of the instant disclosure, a method for preparing the PFAS-free textile material includes combining (a) the polyamine polymer and/or polyamide polymer, (b) the heat-resistant silicone elastomer, and (c) the mineral fiber to form a combined polymer resin. The combined polymer resin can be extruded (e.g., at 200-275° C.) to form an acid reactive functionalized polymer layer. In this manner, the acid reactive functionalized polymer layer is configured to have a range of functional properties, including chemical resistance, water resistance, fire resistance, acid neutralization, and/or the ability to allow water vapor to pass through. Subsequently, the acid reactive functionalized polymer layer is positioned proximate to one or more of the above discussed non-acid reactive functionalized layers. The PFRAS-free textile material can be assembled as discussed above.

The step of positioning the acid reactive functionalized polymer layer proximate to the non-acid reactive functionalized layer(s) can include interposing the acid reactive functionalized polymer layer between a top layer and bottom layer each including the non-acid reactive functionalized layer. The acid reactive functionalized polymer layer and/or non-acid reactive functionalized layer can be laser etched as discussed above.

The step of extruding the combined polymer resin to form the acid reactive functionalized polymer layer can further include optional process A or optional process B. Optional process A can include the steps of extruding the combined polymer resin via (e.g., a twin screw extruder) and pumping the extruded combined polymer resin through a film die head. In embodiments using optional process A, the acid reactive functionalized polymer layer can include PDMS present at 23 wt. %, basalt fibers present at 10 wt. %, and a polyamine polymer present at 67 wt. %.

Optional process B can include the steps of extruding the combined polymer resin (e.g., via the twin screw extruder), pelletizing the extruded combined polymer resin to form pelletized material, and extruding the pelletized material (e.g., via a single screw extruder or twin screw extruder) prior to pumping it through the film die head. For example, when optional process B is utilized, the acid reactive functionalized polymer layer can include PDMS present at 23 wt. %, basalt fibers present at 10 wt. %, and a polyamine polymer present at 67 wt. %.

The foregoing description of embodiments of the instant disclosure has been presented for the purpose of illustration and description. It is not intended to be exhaustive nor is it intended to limit the instant disclosure to the precise form disclosed. It will be apparent to those skilled in the art that the disclosed embodiments may be modified in light of the above teachings. The embodiments described are chosen to provide an illustration of principles of the instant disclosure and its practical application to enable thereby one or ordinary skill in the art to utilize the instant disclosure in various embodiments and with various modifications as are suited to the particular use contemplated. Therefore, the foregoing description is to be considered exemplary, rather than limiting, and the true scope of the instant disclosure is that described in the following claims.

What is claimed is:

1. A textile material comprising:
an acid reactive functionalized polymer layer;
a non-acid reactive functionalized layer coupled to the acid reactive functionalized polymer layer;
wherein
the acid reactive functionalized polymer layer comprises:
a polyamide polymer that captures and neutralizes acidic molecules;
a hydrophilic polyether block amide copolymer;
a maleic anhydride-grafted ethylene copolymer;
a non-halogenated flame retardant;
the acid reactive functionalized polymer layer
is fire resistant;
is acid neutralizing;
allows water vapor to transfer through; and
the non-acid reactive functionalized layer and the acid reactive functionalized polymer layer are free of per- and polyfluoroalkyl substances (PFAS).

2. The textile material of claim 1, wherein
the polyamide comprises Nylon 12, Nylon 6, or Nylon 6,6 functionalized with an amine;
the amine comprises:
a pyridine derivative and/or a halogenated-dimethylalkylamine;
a nitrogen that captures and neutralizes acidic molecules;
the halogenated-dimethylalkylamine comprises a general chemical formula of (CH₃)₂N—R—X;
R is an alkyl containing 1-12 carbon atoms; and
X is chlorine or bromine.

3. The textile material of claim 1, wherein the non-halogenated flame retardant comprises one or more of:
melamine polyphosphate;
aluminum polyphosphate;
aluminum hydroxide; and
magnesium hydroxide.

4. The textile material of claim 1, wherein
the hydrophilic polyether block amide copolymer is present at 23 wt. % to wt. %.

5. The textile material of claim 1 wherein
the non-halogenated fire retardant is present at 5 wt. % to 15 wt. %.

6. The textile material of claim 1, wherein
the polyamide polymer is present at 40-55 wt. %.

7. The textile material of claim 1, wherein
the acid reactive functionalized polymer layer is coupled to the non-acid reactive functionalized layer via at least one of an adhesive bond and a thermal bond.

8. The textile material of claim 1, wherein
the hydrophilic polyether block amide copolymer
increases the moisture vapor transmission rate of the acid reactive functionalized polymer layer;
comprises
a Shore D hardness value of 35 or greater;
a flexural modulus of at least 70 MPa (10,153 psi); and
the acid reactive functionalized polymer layer impermeable to liquids.

9. The textile material of claim 1, wherein
the maleic anhydride-grafted ethylene copolymer is present at 3 wt. % to 15 wt. %.

10. The textile material of claim 1, wherein
the non-acid reactive functionalized layer
(a) is flame resistant; and/or
(b) comprises:
a nylon material;
a cotton material;
an aramid material; and
a spandex material.

11. The textile material of claim 1, wherein
the non-acid reactive functionalized layer comprises a first non-acid reactive functionalized layer and a second non-acid reactive functionalized layer; and
the acid reactive functionalized polymer layer is interposed between the first non-acid reactive functionalized layer and the second non-acid reactive functionalized layer.

12. The textile material of claim 1, wherein
one or more of the acid reactive functionalized polymer layer and the non-acid reactive functionalized layer comprise a thickness of up to 10 μm.

13. A method for preparing a textile material, comprising:
extruding a polyamide polymer to form a first extrusion product, the polyamide polymer captures and neutralizes acidic molecules;
extruding a combination of the first extrusion product, a hydrophilic polyether block amide copolymer, a maleic anhydride-grafted ethylene copolymer, and a non-halogenated flame retardant to form a second extrusion product;
pelletizing the second extrusion product;
extruding the second extrusion product to form an acid reactive functionalized polymer film;
affixing the acid reactive functionalized polymer film to a non-acid reactive functionalized layer;
wherein
the acid reactive functionalized polymer film
is water resistant;
is chemical resistant;
is fire resistant;
is acid neutralizing;
allows water vapor to transfer therethrough; and
the non-acid reactive functionalized layer and the acid reactive functionalized polymer layer are free of per- and polyfluoroalkyl substances (PFAS).

14. The method of claim 13, wherein
the polyamide polymer comprises Nylon 12, Nylon 6, or Nylon 6,6 functionalized with an amine;
the amine comprises:
a pyridine derivative and/or a halogenated-dimethylalkylamine;
a nitrogen that captures and neutralizes acidic molecules;
the halogenated-dimethylalkylamine comprises a general chemical formula of (CH₃)₂N—R—X;
R is an alkyl containing 1-12 carbon atoms; and
X is either chlorine or bromine.

15. The method of claim 13, wherein
the step of affixing the acid reactive functionalized polymer layer proximate to the non-acid reactive functionalized polymer layer comprises:
affixing the acid reactive functionalized polymer layer to the non-acid reactive functionalized polymer layer via one or more of an adhesive bond or a thermal bond.

16. The method of claim 13, wherein
the non-acid reactive functionalized layer comprises a first non-acid reactive functionalized layer and a second non-acid reactive functionalized layer; and
the step of affixing the acid reactive functionalized polymer layer proximate to the non-acid reactive functionalized layer comprises:
interposing the acid reactive functionalized polymer layer between the first non-acid reactive functionalized layer and the second non-acid reactive functionalized layer.

17. The method of claim 13, wherein
the non-acid reactive functionalized layer comprises one or more of:
a nylon material;
a cotton material;
an aramid material; and
a spandex material.

18. The method of claim 13, wherein
the non-halogenated flame retardant comprises one or more of:
melamine polyphosphate;
aluminum polyphosphate;
aluminum hydroxide; and
magnesium hydroxide.

19. The method of claim 13, wherein one or more of
the hydrophilic polyether block amide copolymer is present at 23 wt. % to 80 wt. %;
the non-halogenated fire retardant is present at 15 wt. % to 75 wt. %;
the polyamide polymer is present at 40-80 wt. %; and
the maleic anhydride-grafted ethylene copolymer is present at 3 wt. % to 15 wt. %.

20. The method of claim 13, wherein
the hydrophilic polyether block amide copolymer
increases the moisture vapor transmission rate of the acid reactive functionalized polymer layer;
comprises
a Shore D hardness value of 35 or greater; and
a flexural modulus of at least 70 MPa (10,153 psi); and the acid reactive functionalized polymer layer impermeable to liquids.
